(19) United States
(12) Patent Application Publication
(10) Pub. No.: US 2026/0089209 A1
(43) Pub. Date: Mar. 26, 2026

(54) Rebalancing Caching Layer for Distributed Database System

(71) Applicant: Salesforce, Inc., San Francisco, CA (US)

(72) Inventors: Charan Reddy Guttapalem, Fremont, CA (US); Venkateswararao Jujjuri, Beaverton, OR (US); Senthilkumar Narayanasamy, San Jose, CA (US); Sushanth Rai, San Jose, CA (US); Feilong Song, Markham (CA)

(21) Appl. No.: 18/894,158

(22) Filed: Sep. 24, 2024

(51) Int. Cl. H04L 67/1031; G06F 11/34; G06F 16/2455; G06F 16/27

(52) U.S. Cl. CPC H04L 67/1031; G06F 11/3433; G06F 16/24552; G06F 16/278

(57) ABSTRACT

Techniques are disclosed for dynamically rebalancing a caching layer within a distributed database system hosted across a distributed computing environment. In some embodiments, a system that includes a plurality of physical nodes implementing a hosting service deploys containers that serve as caching nodes for the distributed database system. Each container is configured to store cached data within a memory internal to its respective physical node. The system monitors the storage utilization and read/write activity across the caching containers, and based on this monitoring, redistributes data to balance the load across the cluster. Rebalancing can include identifying underutilized and overutilized containers, retrieving subsets of data from overworked containers from persistent storage, and storing the data in underutilized containers.

### BACKGROUND

### Technical Field

This disclosure relates generally to database systems, and, more specifically, to data storage for distributed database systems.

### Description of the Related Art

Distributed database systems can be deployed to provide improved performance, reliability, and fault tolerance in handling large datasets. In such systems, data can be distributed across multiple nodes within a cluster, each node potentially residing in a different geographical region or area zone (AZ). This distribution enables the database to scale horizontally by adding more nodes to handle increased data volumes and transaction rates. Additionally, by replicating data across nodes in different area zones, these systems can enhance resilience against localized failures. When one node or even an entire AZ becomes unavailable, redundant copies of the data stored in other AZs can continue to serve requests, thereby maintaining uninterrupted access and operational continuity.

### BRIEF DESCRIPTION OF THE DRAWINGS

FIG. 1 is a block diagram illustrating a computing system that implements a database cache for a database system that maintains data in a separate persistent storage, according to some embodiments.

FIG. 2 is a block diagram illustrating an example rebalance system, according to some embodiments.

FIG. 3 is a block diagram illustrating an example auditor exchange, according to some embodiments.

FIG. 4 is block diagram illustrating an example rebalance exchange, according to some embodiments.

FIG. 5 is a block diagram illustrating an example autoscaling system, according to some embodiments.

FIGS. 6A-6C are flow diagrams illustrating embodiments of methods implementing techniques described herein.

FIG. 7 is a block diagram illustrating one embodiment of an exemplary multi-tenant system for implementing various systems described herein.

### DETAILED DESCRIPTION

In distributed database systems, a caching layer may be implemented between the database servers and the persistent storage to reduce latency when accessing data. In some examples, caching is handled by containers (e.g., virtual machines (VMs)) that store frequently accessed data closer to the database servers, which can minimize the need to retrieve data from slower, external storage systems such as cloud storage. However, challenges in managing cache distribution across multiple nodes may arise due to several factors. For example, old data may remain in the cluster for an extended period of time, which may lead to data staleness and inefficiency in cache utilization. Additionally, the cluster's data placement policy for new data may contribute to imbalances when new data is preferentially assigned to certain nodes. As the workload grows, these issues may contribute to the “banding problem” in which certain older cache nodes (referred to below as “cachies”) may become overloaded while newer cachies remain underloaded, leading to uneven load distribution across the cluster (e.g., uneven distribution of data within cachies). Additionally, once a cachie is full, it may stop accepting write requests, further aggravating the load distribution problem as newer cachies take on more write traffic. Scale-up and scale-down operations within the cluster may also exacerbate the banding problem by failing to redistribute data evenly across all nodes.

In various embodiments, the present disclosure introduces a rebalancing (also redistributing) mechanism for a distributed database system that addresses the inefficiencies mentioned above. In some aspects, in this system, a distributed computing environment may include multiple physical nodes, each hosting one or more cachies that implement a cache layer between the database and storage layers. The cache may be stored within the internal memory of the physical nodes, which may enable faster access than relying on external storage alone. In some embodiments, the system can monitor the storage utilization of each cachie and periodically determine an average utilization (also average load) across the cluster (e.g., the average utilization of the plurality of cachies in the cluster). In some cases, when a cachie detects that its utilization is below the average, it may identify a more heavily utilized cachie and pull data from it by obtaining a snapshot of the overutilized cachie's contents. This snapshot may allow the underutilized cachie to fetch relevant data from the persistent storage (e.g., Amazon Simple Storage Service® (Amazon S3®)) and relieve the burden of the overutilized cachie without directly affecting its performance. In some aspects, the redistribution of data may be managed automatically by the system, enabling dynamic load balancing and improved overall efficiency.

In some embodiments, the proposed rebalancing mechanism improves the performance and scalability of the caching layer in a distributed database system. By implementing a dynamic rebalancing scheme for cachies, the system may provide a more even distribution of cached data across multiple nodes (e.g., servers), which may lead to improved load balancing and consistent performance. In some aspects, the approach can minimize the load on overworked nodes by shifting data to underutilized nodes, leading to more consistent performance across the cluster. Additionally, the system's reliance on snapshots (e.g., data snapshot within a cachie) and persistent storage for rehydration may avoid placing additional strain on already overloaded nodes during the rebalancing process. In some embodiments, the ability to redistribute data based on real-time utilization metrics allows the cache layer to scale effectively, handle fluctuating workloads, and maintain high availability and lower latency, which may ultimately result in a more efficient and resilient distributed database architecture.

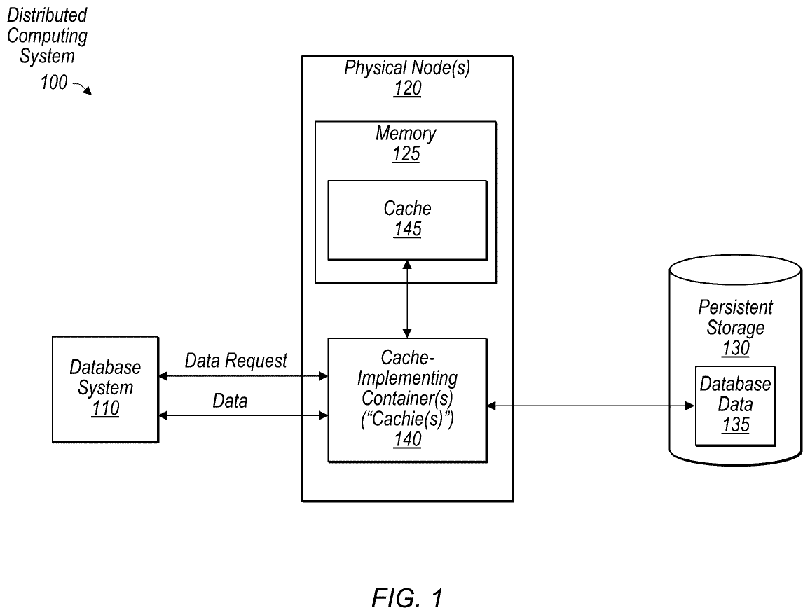

Turning now to FIG. 1, a block diagram of a distributed computing system 100 is depicted. In illustrated embodiment, distributed computing system 100 includes database system 110, one or more physical nodes 120, and persistent storage 130. Physical nodes 120 further include internal memory 125 and one or more cache-implementing containers 140. In some embodiments, distributed computing system 100 may be implemented differently than shown in FIG. 1.

Distributed computing system 100, in some embodiments, implements a hosting service (e.g., Amazon® Web Services, Microsoft® Azure, Google® Cloud) that allows users of that service to provision various resources (e.g., computing resources, storage resources, network resources, etc.). Examples of such resources may include database system 110, persistent storage 130, container 140, etc. Computing system 100 may be distributed across multiple physical computing systems, which may be distributed across multiple area zones (AZs). For example, distributed computing system 100 may be implemented by multiple server farms, which may reside in different geographic locations. In other embodiments, however, system 100 is implemented utilizing a local or private infrastructure as opposed to a public cloud.

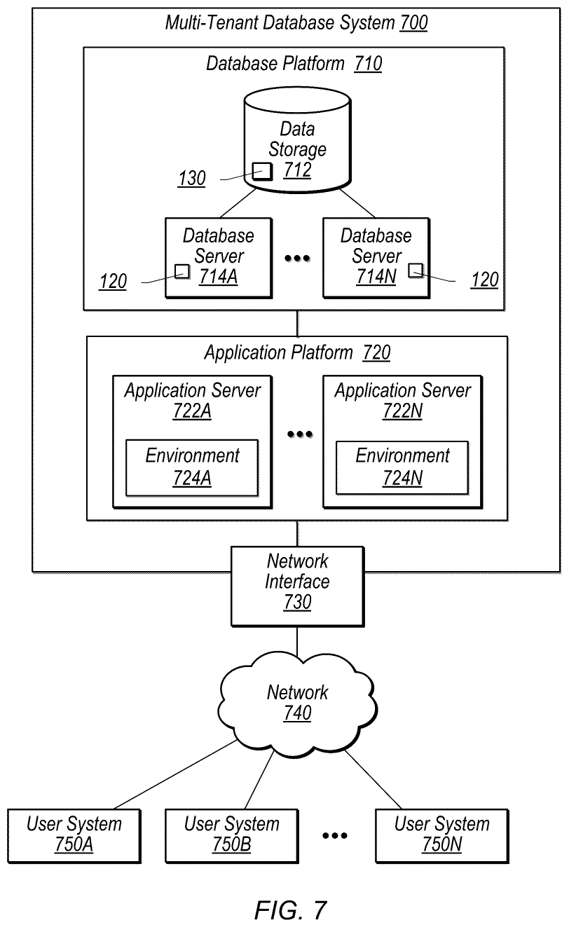

Database system 110 may correspond to any suitable database system. In some embodiments, system 100 is a relational database management system (RDBMS), which may be implemented using, for example, Oracle®, MySQL®, Microsoft® SQL Server, PostgreSQL®, IBM® DB2, etc. Accordingly, system 110 may be configured to store data in one or more data tables, indexes, temporary, tables, etc. for servicing data requests. In some embodiments, data requests are expressed using structured query language (SQL); but in other embodiments, other query declarative languages may be supported. In some embodiments, database system 110 may include a multi-tenant database (e.g., 700 as discussed below with respect to FIG. 7) in which multiple tenants may each store a respective set of data in the database. For example, the multi-tenant database may include a first set of data belonging to a non-profit organization (e.g., a first tenant) and a set of data belonging to a company (e.g., a second tenant). In some embodiments, database system 110 is a distributed database system that is implemented across multiple PNs such as nodes 120.

In some aspects, physical nodes (PNs) 120 are physical computers configured to implement a hosting service of distributed computing system 100. For example, PNs 120 may be blade/rack servers inserted into server racks, which may correspond to one or more Amazon Elastic Compute Cloud® (EC2) instances. As part of providing a host service, PNs 120 may host containers that implement one or more lightweight, standalone, and portable execution environments for applications and their dependencies. PNs 120 may support any suitable types of containers including, but not limited to, virtual machines (VMs), Docker® containers, Linux Containers (LXCs), etc. For example, database system 110 may execute within multiple containers hosted on PNs 120. In some cases, PN 120 may also execute containers 140. To implement various functionalities, PNs 120 may include one or more processors and internal memory 125, which may be referred to as an instance storage. Internal memory 125 may include non-volatile memory including, but not limited to, hard disk drives (HDDs), solid state drives (SSDs), optical storage, etc., as well as various volatile memory including DRAM, DDR RAM, SRAM, EDO RAM, Rambus RAM, etc. Memory 125 may include program instructions such as those of container 140, data such as cache 145, etc.

In some examples, persistent storage 130 stores database data 135 for database system 110. Persistent storage 130 may be implemented using single or multiple storage devices that are connected together on a network (e.g., a storage attached network (SAN), network attached storage (NAS), etc.) and configured to redundantly store information in order to prevent data loss. In some embodiments, data 135 written to persistent storage 130 may be persisted across multiple AZs using a replication service. In some embodiments, persistent storage 130 is implemented as an object storage in contrast to memory 125, which, in some embodiments, implements a block storage. In some embodiments, persistent storage 130 is a cloud-based storage such as an Amazon S3® bucket. Persistent storage 130 may also afford different levels quality of service (QoS) based on pricing, physical proximity to PNs 120, etc. As noted above, because persistent storage 130 is external to physical nodes 120, in various embodiments, data requests to persistent storage 130 may experience higher latency than data requests to internal memory 125.

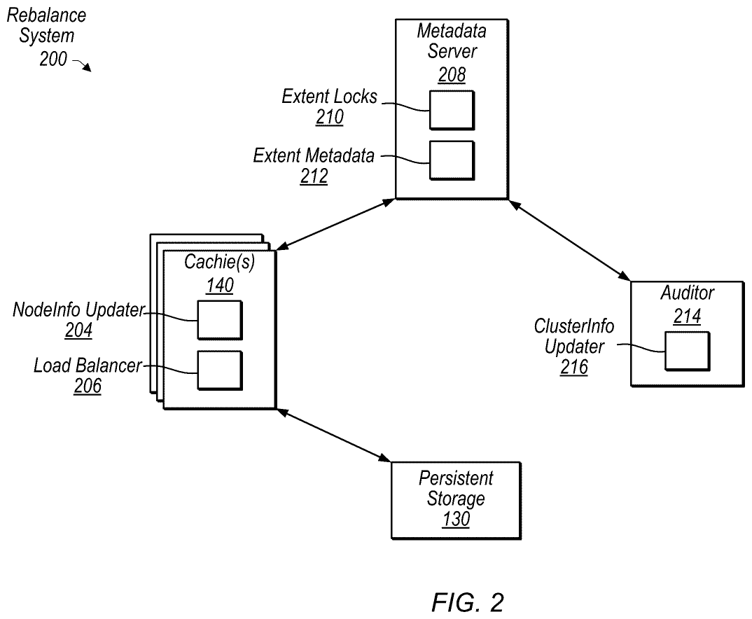

In some embodiments, cache-implementing containers 140 (cachies) are container hosted by physical node 120 and executable to implement cache 145 for database system 110 in internal memory 125 in order to reduce the latency for data requests accessing data 135 from persistent storage 130. As will be described in more detail with respect to FIG. 2, containers 140/cachies 140) may be deployed to multiple nodes 120 that implement portions of a distributed cache layer for database system 110. A given container 140 may also include multiple software components to manage various functions associated with caching database data 135 in cache 145 within memory 125. These functions may include hydration of cache 145 (i.e., the retrieval of data 135 from persistent storage 130 into a cache 145 before the data is requested by database system 110), servicing cache hits from memory 125, and servicing cache misses from persistent storage 130, etc.

Turning now to FIG. 2, a block diagram illustrating an example rebalance system 200 is shown. In the illustrated embodiment of FIG. 2, rebalance system 200 includes multiple components in communication, including metadata server 208, one or more cachies 140, auditor 214, and persistent storage 130. In some examples, rebalance system 200 provides a mechanism for dynamically redistributing or rebalancing data stored across one or more cachies 140 (e.g., such that each cachie 140 is utilized similarly to other cachies 140 in a cluster) to address potential imbalances in load distribution.

In some embodiments, rebalance system 200 represents a distributed architecture for managing a cache layer within a distributed database system. In this configuration, rebalancing system 200 may prevent overloading specific cachies 140, thereby maintaining consistent performance across the cache cluster and improving resource utilization. In some aspects, rebalance system 200 works by continuously monitoring the status of each cachie 140 and dynamically redistributing data when necessary.

In some cases, metadata server 208 (e.g., Apache® Zookeeper) functions as a centralized metadata store and coordinator for the entire system 200. In some examples, metadata server 208 can be implemented using Apache® Zookeeper or similar services, which may provide metadata management capabilities and fault tolerance. In some examples, metadata server 208 stores information such as extent locks 210, which may control access to specific data segments (e.g., data extents) during rebalancing operations, and extent metadata 212, which may track additional information about extents (e.g., which cachies 140 are responsible for storing specific data and the current status of the data within rebalance system 200). An extent, as used herein, may refer to a packaged group of data fragments, such as database records or other data units. In some instances, extent locks 210 can provide data consistency by allowing only one cachie 140 to modify a particular extent at a time. The extent metadata 212 may be used to keep track of the allocation and movement of data between cachies 140 during rebalancing operations.

In some embodiments, cachies 140 are the primary caching containers deployed across multiple physical nodes (e.g., servers). In some aspects, cachies 140 may be deployed (e.g., in servers) across one or more AZs in one or more geographical locations. Each cachie 140 may be implemented as a container (e.g., Docker or a VM) that provides a localized cache within the distributed database system. The cachies 140 may host software components that enable communication with metadata server 208 and dynamic load balancing across the cluster. By way of example, each cachie 140 may be equipped with nodeinfo updater 204 and load balancer 206. In some aspects, nodeinfo updater 204 can periodically gather and report a respective cachie's 140 current storage utilization (e.g., the percentage of its allocated storage currently in use) to metadata server 208. This utilization data may be used to determine when rebalancing may be performed. The load balancer 206 within a particular cachie 140 may be responsible for analyzing the average storage utilization data retrieved from metadata server 208 and determine whether data will redistributed (e.g., moved from an overutilized cachie 140 with a higher percentage of storage being utilized). If a determination is made (e.g., by cachie 140) for a redistribution of data, load balancer 206 may trigger actions to offload data from an overutilized or overworked cachie 140 (e.g., a cachie 140 may retrieve data from an overutilized cachie 140 from persistent storage 130 and the overutilized cachie 140 may subsequently delete its moved data). In some embodiments, only underutilized cachies 140 (e.g., cachies 140 with current storage utilizations below the average of storage utilizations of the cluster) may perform the action of redistributing data such as retrieving data from one or more overutilized cachies 140 (e.g., via persistent storage 130).

In addition to storage utilization, nodeinfo updater 204 may periodically gather and report cachie's 140 current request rate to metadata server 208. For example, data (e.g., fragments, extents) within a particular cachie 140 may receive a frequent number of read and/or write requests (e.g., from database system 110). In some cases, a cachie's 140 request rate may be reported to metadata server 208 and similar to the process as discussed above with respect to storage utilization, a cachie 140 that is overutilized with respect to read and/or write requests may have its data moved to another underutilized cachie 140 (e.g., an underutilized cachie 140 may retrieve this data from persistent storage 130 and the overutilized cachie 140 may subsequently delete the moved data).

In some embodiments, persistent storage 130 (e.g., Amazon S3®) serves as the primary, long-term storage layer for the database system. For example, when a cachie 140 does not have the requested data cached locally, it can retrieve the data from persistent storage 130 (e.g., with metadata server 208 managing and directing the retrieval). Although accessing persistent storage 130 may introduce higher latency, it may allow for data to be available even if it is not stored in any cachie 140. In some embodiments, a cachie 140 may store its respective data (e.g., as a backup copy) to persistent storage 130.

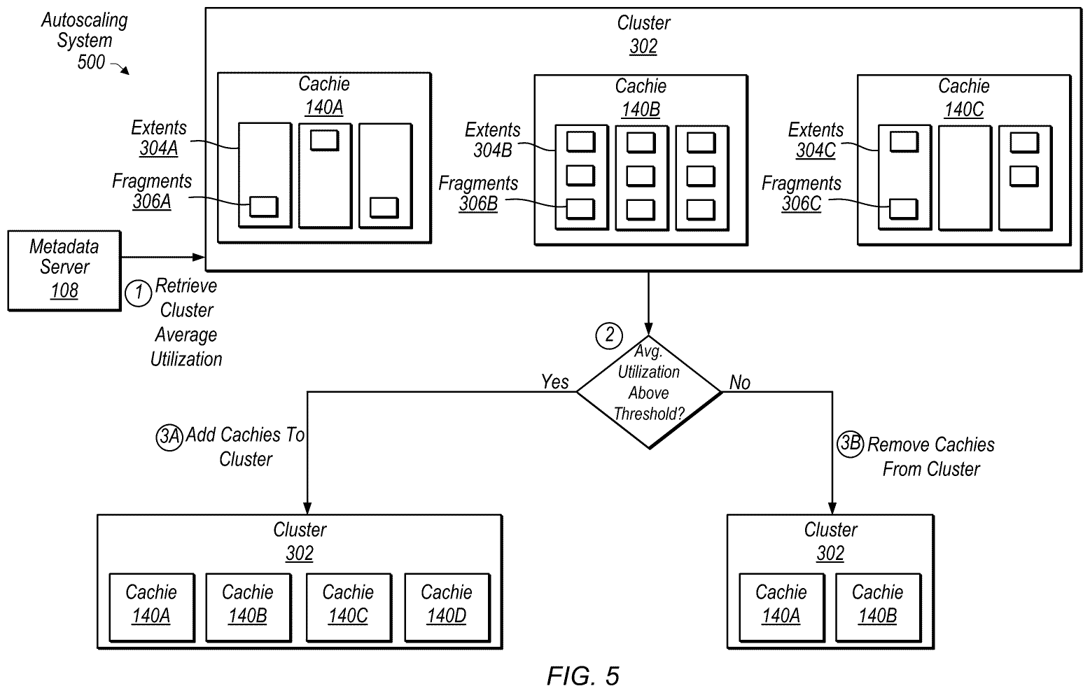

In some examples, auditor 214 is a specialized component (e.g., one of the plurality of cachies 140) that is elected to perform higher-level management tasks for the cluster. Auditor 214 may include clusterinfo updater 216, which may periodically aggregate storage utilization data from all cachies 140 (e.g., within a cluster) and compute cluster-wide metrics, such as the average storage utilization and total storage capacity. In some examples, if the average utilization of the cluster exceeds a predefined threshold, the system 200 may automatically scale out by deploying additional cachies 140. Conversely, if utilization is consistently low, the system may scale in by decommissioning underutilized cachies 140 to optimize resource usage. This autoscaling process will be described in further detail with respect to FIG. 5 below.

In some embodiments, the rebalancing process may follow a structured workflow. First, each cachie 140 may periodically retrieve a cluster usage report from metadata server 208. Based on this report, each cachie 140 may determine its own utilization (e.g., storage utilization, request rate) relative to the cluster average. If a cachie 140's utilization is below the cluster average, it may identify a target cachie 140 that is overutilized. The underutilized cachie 140 may then retrieve a snapshot of the target cachie's 140 extents from metadata server 208 and/or persistent storage 130. In some examples, this snapshot can provide detailed information about the extents stored in the target cachie 140 and enable the underutilized cachie 140 to selectively pull and cache the data extents locally. During this process, the underutilized cachie 140 may acquire extent locks 210 to ensure that no other cachie 140 is working on the same extents simultaneously, thereby preventing data conflicts.

Once the data has been successfully rebalanced, the underutilized cachie 140 may update extent metadata 212 in metadata server 208 to reflect that it is now responsible for caching the extents. The previously overutilized cachie 140, which was the original holder of the extents, may recognize that it is no longer responsible for those extents and may delete the data, reducing its storage utilization. This dynamic rebalancing process may allow for the load to be evenly distributed across cachies 140 in the cluster, preventing any one cachie 140 from becoming overutilized with the amount of respective storage being utilized.

Throughout this process, metadata server 208 may play a central role by maintaining metadata, coordinating extent locks 210, and facilitating communication between cachies 140. Offloading the bulk of the coordination tasks to metadata server 208 (e.g., Apache® Zookeeper) may allow system 200 to maintain high availability and resilience, even in the event of failures. Furthermore, the election of auditor 214 may allow the cluster to be continuously monitored and optimized in real-time based on accurate, up-to-date utilization (e.g., storage utilization, request rate) data.

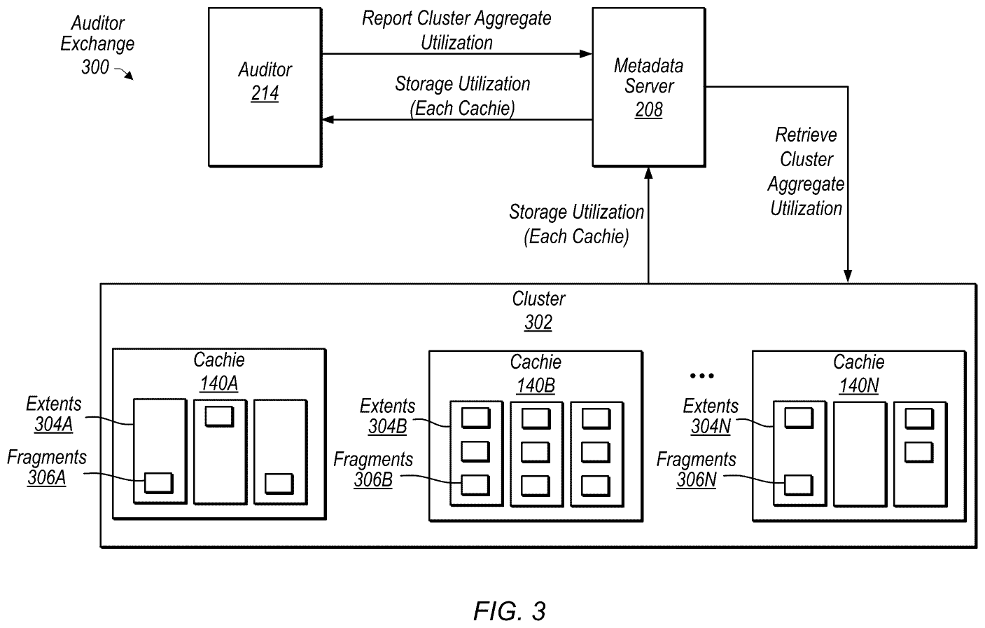

Turning now to FIG. 3, a block diagram illustrating an example auditor exchange 300 is shown. In the example embodiment of FIG. 3, auditor exchange 300 includes cluster 302 comprising one or more cachies 140 (e.g., cachie 140A, cachie 140B, through cachie 140N representing N number of cachies). In some aspects, each cachie 140 within cluster 302 stores cached data in the form of one or more data extents 304 (e.g., extents 304A, extents 304B, through extents 304N representing N number of extents), which further include one or more data fragments 306 (e.g., fragments 306A, fragments 306B, through fragments 306N representing N number of fragments). In some cases, a particular cachie 140 may create a new extent 304 after its existing extents 304 have been populated with fragments 306 (e.g., an extent 304 has reached its respective storage capacity with fragments 306) while in other cases, each extent 304 may vary in the number of fragments 306 it contains.

In some embodiments, auditor 214 functions as a central coordinator within auditor exchange 300. In some embodiments, auditor 214 is elected (e.g., within set of cachies 140A through 140N). In some aspects, auditor 214 may be responsible for collecting storage utilization data from each cachie 140 within cluster 302. In some embodiments, auditor 214 retrieves storage utilization information directly from each cachie 140 within cluster 302. In other embodiments, this information may be sourced via metadata server 208, which aggregates the storage utilization data from cachies 140.

In some cases, once auditor 214 collects the storage utilization data from cachies 140, it may determine the average storage utilization across cluster 302. After calculating the average utilization, auditor 214 may report (e.g., provide a report) this information back to metadata server 208. In some cases, this report may include an aggregation of both the average storage utilization for cluster 302 and the individual utilization details of each cachie 140 node. Subsequently, cachies 140 within cluster 302 may retrieve this comprehensive cluster utilization report (e.g., from metadata server 208) enabling them to make decisions regarding data redistribution. In some instances, the report gives each cachie 140 node a full view of cluster 302, including details on aggregate cluster usage and the utilization of all individual cachies 140. This may allow cachies 140 to identify overutilized nodes for rebalancing.

As discussed above, the average storage utilization data may be used in the rebalancing operations carried out across cluster 302. For example, if a particular cachie 140 is overutilized due to high storage occupancy, the system may redistribute data from an overutilized cachie 140 to an underutilized cachie 140 within cluster 302. In some embodiments, data may be redistributed to cachies 140 in different area zones (e.g., different geographical locations) and/or different servers (e.g., each cachie 140 within a cluster 302 may be located in a different AZ and/or server). By considering both storage and operational load, auditor 214 may help maintain an optimal balance (e.g., workload balance), thereby preventing bottlenecks and ensuring that no individual cachie 302 becomes overburdened.

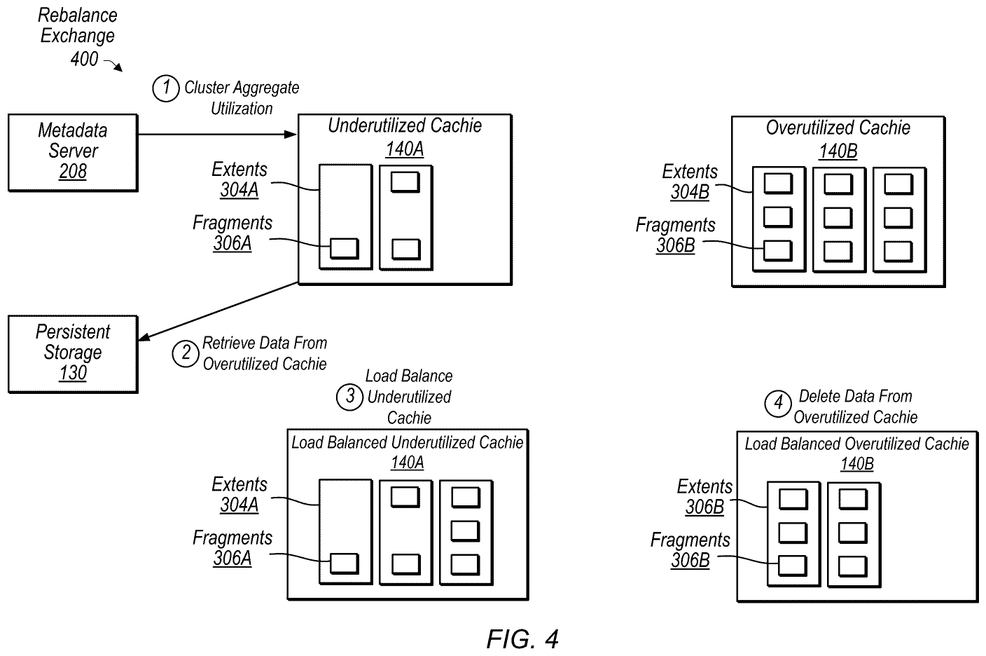

Turning now to FIG. 4, a block diagram illustrating an example rebalance exchange 400 is depicted. In the illustrated embodiment of FIG. 4, underutilized cachie 140A and overutilized cachie 140B are shown going through a process of load balancing across a distributed cache system.

In some embodiments, rebalance exchange 400 involves four primary steps aimed at redistributing data between cachies 140 in a cluster (e.g., cluster 302) to achieve balanced storage utilization across the cluster. As shown in FIG. 4, underutilized cachie 140A and overutilized cachie 140B participate in this process, with data being shifted from overutilized cachie 140B to underutilized cachie 140A.

In Step 1, labeled “Cluster Aggregate Utilization,” the underutilized cachie 140A may receive the cluster utilization report (e.g., from metadata server 208), which may include average storage utilization data and/or the utilization details for all other cachies 140 in the cluster. In some embodiments, the cachies 140 that have the lowest storage utilizations in the cluster (e.g., the least amount of data stored) are prioritized over other cachies 140 with higher storage utilizations. In some embodiments, load balancer 206 within underutilized cachie 140A as discussed above with respect to FIG. 2 is involved with pulling a report that includes the average storage utilization data from metadata server 208. In some embodiments, load balancer 206 may also be involved with making a determination for underutilized cachie 140A on whether to act or not (e.g., whether to pull data from another overutilized cachie 140B). The average utilization may represent metrics such as the average storage usage or average access frequency (e.g., average access of read and/or write requests) across all cachies 140 in cluster (e.g., cluster 302 from FIG. 3). In some examples, using the report, underutilized cachie 140A may identify which nodes are overutilized based on the individual utilization details of other cachies 140 in the report, and it may compare its own storage utilization to the cluster average storage utilization and determine that it is operating below this threshold, signaling that it can take on additional data from one or more overutilized cachies 140B.

In Step 2, labeled “Retrieve Data From Overutilized Cachie,” underutilized cachie 140A may initiate a data retrieval process. In some instances, this involves identifying an overutilized cachie 140B within the cluster that exceeds the cluster's average storage utilization (e.g., based on reports from metadata server 208). In some aspects, underutilized cachie 140A may retrieve data, such as extents 304B and/or fragments 306B, from persistent storage 130. In an alternative embodiment, underutilized cachie 140A may directly retrieve data from overutilized cachie 140B. Before transferring the data, extent locks (e.g., extent locks 210 from FIG. 2) may be applied to ensure that no other process or cachie modifies the data during the transfer.

The retrieval process may provide data consistency and may prevent conflicting operations by coordinating through metadata server 208. During this step, metadata server 208 may also update the extent metadata (e.g., extent metadata 212 from FIG. 2) to reflect that underutilized cachie 140A is now the primary holder of the retrieved data.

In Step 3, labeled “Load Balance Underutilized Cachie,” underutilized cachie 140A may integrate the newly retrieved extents 304A and fragments 306A into its local storage. This integration may include rehydrating data from persistent storage 130 or directly from overutilized cachie 140B. As part of the load balancing process, underutilized cachie 140A may inform metadata server 208 that it is now the primary data holder for the transferred extents 304 and fragments 306.

In some embodiments, the rebalancing process is finalized in Step 4, labeled “Delete Data From Overutilized Cachie.” At this step, overutilized cachie 140B may recognize that it is no longer responsible for the extents 304B and fragments 306B that were transferred to underutilized cachie 140A. As a result, overutilized cachie 140B may delete this data from its local storage (e.g., during its garbage collection routine), thereby reducing its storage utilization. This deletion may involve removing entire extents 304B and/or selectively purging fragments 306B across multiple extents 304B, depending on the data that was rebalanced.

In some examples, the overall process of FIG. 4 illustrates a dynamic mechanism for redistributing data between cachies 140 based on their respective storage utilizations. By offloading data from overutilized cachies 140B to underutilized cachies 140A, rebalance exchange 400 may help maintain even performance across the distributed cache cluster. The metadata server 208, extent locks 210, and extent metadata 212 may play a role in providing data consistency and synchronization throughout this process. Additionally, these steps may align with the locking techniques discussed in FIG. 2, where the rebalancing system utilizes these locks and metadata to coordinate data transfers while preserving data integrity.

Turning now to FIG. 5, a block diagram illustrating an example autoscaling system 500 is depicted. In the example embodiment of FIG. 5, autoscaling system 500 illustrates a process for cluster 302 to increase or decrease its respective number of cachies 140 based on the average cluster utilization. In some embodiments, autoscaling system 500 can either add or remove cachies 140 from cluster 302 depending on whether the utilization across the cluster exceeds or falls below a predefined threshold (e.g., also may be notated as a watermark value).

In some examples, cluster 302 in FIG. 5 includes one or more cachies 140 (e.g., cachie 140A, cachie 140B, cachie 140C), where each cachie 140 may cache a portion of the data stored within the distributed database system, such as extents 304 and fragments 306. In Step 1, labeled “Retrieve Cluster Average Utilization,” metadata server 208 may gather utilization metrics from all cachies 140 within cluster 302. This cluster utilization data may include metrics like average storage utilization (e.g., how full with data the cachies 140 are across cluster 302) or request rate (e.g., the frequency of read and/or write requests for cachies 140 across cluster 302). Metadata server 208 may communicate this information back to cluster 302, or the data may be retrieved directly by software components within cachies 140, such as a Load Balancer (e.g., Load Balancer 206 from FIG. 2).

In Step 2, labeled “Average Utilization Above Threshold?,” the autoscaling system 500 may determine whether the average utilization of cluster 302 exceeds a predefined threshold. This threshold may be set based on storage usage, access frequency, or other relevant metrics. For example, if the average utilization indicates that the existing cachies 140 in cluster 302 are becoming overutilized or reaching their storage capacity limits, the autoscaling system 500 may determine that more resources (e.g., additional cachies) are needed to maintain balanced performance across the cluster.

If the determination in Step 2 is that the average utilization is above the threshold, the process may proceed to Step 3A, labeled “Add Cachies to Cluster.” In this step, additional cachies 140 may be added to cluster 302 to accommodate the increased load. For example, in FIG. 5, an additional cachie 140D is introduced to cluster 302. By adding more cachies 140, the system may distribute data more evenly and prevent individual cachies 140 from becoming overutilized, thus potentially reducing the risk of performance bottlenecks. In some embodiments, adding more cachies 140 does not automatically trigger data rebalancing as future write operations from clients may prioritize these newly added cachies 140 with more available capacity.

Alternatively, if the determination in Step 2 is that the average utilization is below the watermark, the process may proceed to Step 3B, labeled “Remove Cachies From Cluster.” In this scenario, cluster 302 may be overprovisioned, with one or more cachies 140 operating below their capacity, indicating that some resources are underutilized. To optimize resource usage and reduce operational costs, autoscaling system 500 may remove one or more underutilized cachies 140 from cluster 302. For instance, FIG. 5 illustrates the removal of cachie 140C from cluster 302, leaving only cachies 140A and 140B.

Throughout this autoscaling process, metadata server 208 may play a role in managing and storing the utilization data. By monitoring the average storage utilization across cluster 302 and dynamically adjusting the number of deployed cachies, autoscaling system 500 may allow cluster 302 to efficiently handle varying workloads while avoiding resource waste.

In some examples, the ability to dynamically add or remove cachies 140 within cluster 302 may provide benefits in distributed database environments. For example, during peak usage periods when demand on the system is high, additional cachies 140 may be deployed to prevent any single cachie 140 from becoming overburdened. Conversely, during off-peak times, the system can automatically scale down by removing excess cachies 140 to conserve resources. This autoscaling capability may improve both the performance and cost-effectiveness of the system.

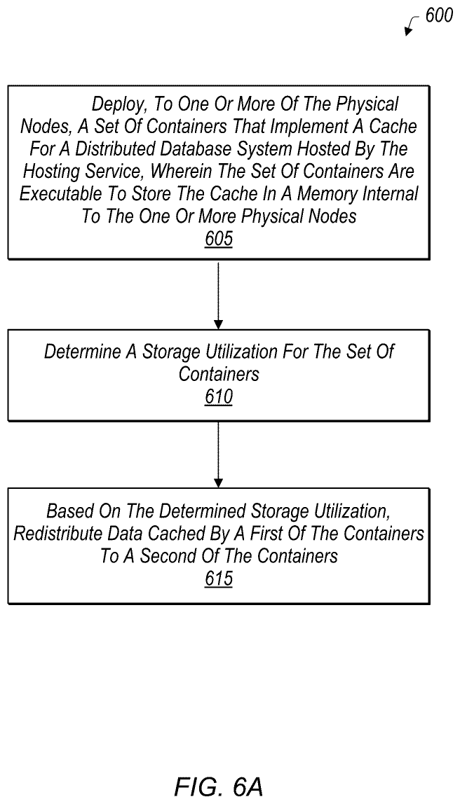

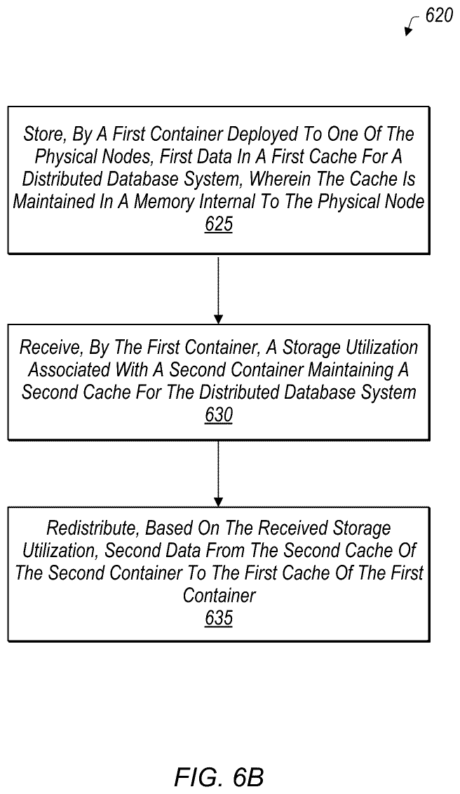

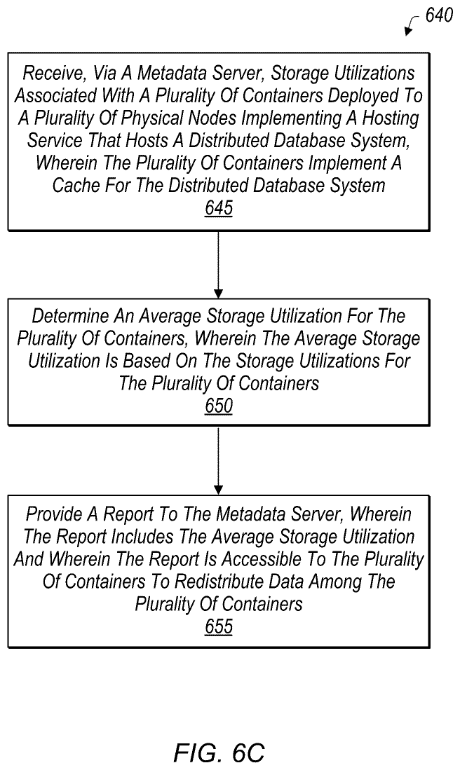

Turning now to FIG. 6A, a flow diagram of a method 600 is shown. Method 600 is one embodiment of a method that is performed by a computing system that implements a database cache as described herein such as distributing computing system 100. In various embodiments, method 600 may be performed by executing program instructions stored on a non-transitory computer-readable storage medium. In some embodiments, method 600 includes more or fewer steps than shown.

Method 600 begins in step 605 with the computing system deploying, to one or more of the physical nodes, a set of containers that implement a cache for a distributed database system hosted by the hosting service, wherein the set of containers are executable to store the cache in a memory internal to the one or more physical nodes. For example, physical nodes 120 may refer to servers in one or more geographical locations and/or AZs with a set of containers (e.g., cachies 140).

In step 610, the computing system determines a storage utilization for the set of containers. For example, an auditor 214 may determine an average storage utilization for the set of containers (e.g., cachies 140A through cachies 140N) or each individual container (e.g., cachie 140) may determine its own respective storage utilization (e.g., percentage of storage that is being utilized by stored data or a percentage of available space in the cachie).

In step 615, the computing system, based on the determined storage utilization, redistributes data cached by a first of the containers to a second of the containers. For example, data from a first of the containers such as overutilized cachie 140B may be redistributed to a second of the containers such as underutilized cachie 140A.

In various embodiments, method 600 further includes the computing system determining a first storage utilization for the first container and a second storage utilization for the second container, wherein the data is redistributed based on a difference between the first storage utilization and the second storage utilization. For example, in some embodiments, the second container (e.g., an underutilized cachie 140A) that receives data may be chosen from a cluster 302 based on the difference in storage utilization compared with the first container (e.g., an overutilized cachie 140B).

In some embodiments, method 600 further includes determining an average utilization for the set of containers and determining if the first storage utilization exceeds the average utilization. For example, auditor 214 may determine an average utilization for the set of containers (e.g., cachies 140A through cachies 140N) within a cluster 302. Each cachie may make a determination (e.g., via a respective Load Balancer 206 within the cachie 140) if its respective storage utilization exceeds the average utilization determined by auditor 214. In some embodiments, method 600 further includes steps in response to determining that the first storage utilization does not exceed the average utilization, identifying, via a metadata server (e.g., metadata server 208), an overutilized container (e.g., 140B) within the set of containers, wherein the overutilized container has a third storage utilization that exceeds the average utilization, retrieving, from a persistent storage (e.g., 130), a subset of data cached by the overutilized container, and storing the subset of data in a cache of the first container (e.g., 140A). For example, as illustrated in FIG. 4, data from overutilized cachie 140B may be retrieved by underutilized cachie 140A from persistent storage 130. In some aspects, the underutilized cachie 140A may identify an overutilized cachie 140B (e.g., within a cluster 302) by receiving data such as a report from metadata server 208. In some embodiments, method 600 further includes steps for deleting the subset of data from a cache of the overutilized container. For example, after overutilized cachie 140B has a subset of its data moved to underutilized cachie 140A, overutilized cachie 140B can delete the moved subset of data from its respective cache (e.g., 145).

In some embodiments, the redistributed data cached by the first of the containers to the second of the containers comprises a set of data extents, wherein the set of data extents comprises a set of data fragments. For example, as illustrated in FIG. 3, the set of containers (e.g., cachies 140) may each have a set of extents 304 and a corresponding set of fragments 306. In some aspects, during data redistribution (e.g., data moved from one cachie to another cachie), any combination of extents 304 and/or fragments 306 may be moved from one cachie to another cachie. In some embodiments, method 600 further includes steps for electing an auditor from the set of containers, wherein the auditor determines an average utilization for the set of containers. For example, a cachie 140 within a cluster 302 may be elected to be auditor 214. As discussed above, auditor 214 may determine the average storage utilization across a set or plurality of cachies 140.

In some embodiments, method 600 further includes steps for determining whether an average utilization for the set of containers satisfies a threshold and in response to determining that the average utilization satisfies the threshold, adding additional containers to the set of containers. For example, as illustrated in FIG. 5 during step 2, if a determination is made that the average utilization or average storage utilization across a set or plurality of cachies 140 is above a threshold value, the system (e.g., distributed computing system 100) may add additional containers or cachies 140 to the cluster 302. In some embodiments, method 600 further includes steps for determining whether an average utilization for the set of containers satisfies a threshold and in response to determining that the average utilization satisfies the threshold, removing one or more containers from the set of containers. For example, as illustrated in FIG. 5 during step 2, if a determination is made that the average utilization or average storage utilization across a set or plurality of cachies 140 is below a threshold value, the system may remove containers or cachies 140 from the cluster 302.

Turning now to FIG. 6B, a flow diagram of a method 620 is shown. Method 620 is one embodiment of a method that is performed by a computing system that implements a database cache as described herein such as distributing computing system 100. In various embodiments, method 620 may be performed by executing program instructions stored on a non-transitory computer-readable storage medium. In some embodiments, method 620 includes more or fewer steps than shown.

In step 625, the computing system stores, by a first container (e.g., cachie 140) deployed to one of the physical nodes 120, first data in a first cache for a distributed database system 110, wherein the cache is maintained in a memory internal to the physical node. For example, a first cachie 140 within a cluster 302 may be deployed to a physical node 120.

In step 630, the computing system receives, by the first container, a storage utilization associated with a second container maintaining a second cache for the distributed database system. For example, in some embodiments, a first cachie 140 may receive storage utilization associated with another second cachie 140 from the second cachie 140 directly, or in other embodiments, it may receive storage utilization associated with the second cachie from metadata server 208.

In step 635, the computing system redistributes, based on the received storage utilization, second data from the second cache of the second container to the first cache of the first container. For example, in some embodiments, if the second container is overutilized (e.g., cachie 140B), its respective data from its respective cache may be redistributed to another cachie (e.g., underutilized cachie 140A).

In various embodiments, method 620 further includes steps for sending, by the first container, a first storage utilization to a metadata server, wherein the received storage utilization is an average utilization determined based on the first storage utilization and a second storage utilization associated with the second container. For example, the storage utilization as discussed above with respect to step 630 may be an average storage utilization across a plurality or set of cachies 140 (e.g., storage utilization across cachies 140A through 140N which may include a first storage utilization for cachie 140A and a second storage utilization for cachie 140B). In some embodiments, method 620 further includes steps for reporting, by the first container, a request rate indicating a frequency the first container receives read and write requests, wherein the redistributing second data is further based on the request rate. For example, a cachie 140A may report a request rate indicating a frequency of it receiving read and write requests, which may influence the redistribution of data (e.g., if a particular cachie has a high request rate, it may receive less data from another cachie to minimize adding additional computational expense). In some embodiments, method 620 further includes steps for participating in an election to determine an auditor within the set of containers, wherein the auditor provides an average storage utilization, wherein the average storage utilization is the received storage utilization. For example, as discussed above, an election may select or determine auditor 214 within a plurality of cachies 140A through 140N.

Turning now to FIG. 6C, a flow diagram of a method 640 is shown. Method 640 is one embodiment of a method that is performed by a computing system that implements a database cache as described herein such as distributing computing system 100. In various embodiments, method 640 may be performed by executing program instructions stored on a non-transitory computer-readable storage medium. In some embodiments, method 640 includes more or fewer steps than shown.

In step 645, the computing system receives, via a metadata server, storage utilizations associated with a plurality of containers deployed to a plurality of physical nodes implementing a hosting service that hosts a distributed database system, wherein the plurality of containers implement a cache for the distributed database system. For example, auditor 214 may receive (e.g., from metadata server 208) storage utilizations corresponding each cachie 140 within a plurality of cachies within cluster 302.

In step 650, the computing system determines an average storage utilization for the plurality of containers, wherein the average storage utilization is based on the storage utilizations for the plurality of containers. For example, auditor 214 may determine the average storage utilization of cluster 302 based on the storage utilizations of each respective cachie 140 within cluster 302.

In step 655, the computing system a report to the metadata server, wherein the report includes the average storage utilization and wherein the report is accessible to the plurality of containers to redistribute data among the plurality of containers. For example, auditor 214 may provide a report including the average storage utilization data to metadata server 208 which is accessible to the set of cachies 140.

In some embodiments, method 640 further includes steps for determining an average access frequency associated with the plurality of containers, wherein the report includes the average access frequency. For example, as discussed above, average access frequency may include the average number of read and/or write requests for a given cachie 140 which may be includes in the report. In some examples, the computer-implemented method is performed by one of the plurality of containers. For example, auditor 214 may be performing the computer-implemented method. In some cases, the one container is elected from among the plurality of containers. For example, auditor 214 may be elected from a plurality of cachies 140. In some instances, the average storage utilization is based on the data cached by the plurality of containers. For example, the average storage utilization (e.g., calculated by auditor 214) may be calculated based on the data cached by the plurality of cachies 140 (e.g., where the data cached by the plurality of cachies 140 impacts each respective cachie's storage utilization).

In some embodiments, method 640 further includes steps for determining whether the average storage utilization for the plurality of containers satisfies a threshold and in response to determining that the average storage utilization satisfies the threshold, changing the number of containers within the plurality of containers. For example, as discussed above with respect to FIG. 5, the average storage utilization across a cluster of cachies may impact whether to add or remove cachies to or from the cluster. In some aspects, a first container within the plurality of containers is deployed to a first physical node located in a first area zone and a second container within the plurality of containers is deployed to a second physical node located in a second area zone, wherein the first area zone and the second area zone are in different geographical locations. For example, one or more cachies 140 within a cluster may be deployed to one or more nodes 120 where each node may reside in different geographical locations.

### Exemplary Multi-tenant Database System

Turning now to FIG. 7, an exemplary multi-tenant database system (MTS) 700, which may implement functionality of system 100, is depicted. In the illustrated embodiment, MTS 700 includes a database platform 710, an application platform 720, and a network interface 730 connected to a network 740. Database platform 710 includes a data storage 712 and a set of database servers 714A-N that interact with data storage 712, and application platform 720 includes a set of application servers 722A-N having respective environments 724. In the illustrated embodiment, MTS 700 is connected to various user systems 750A-N through network 740. In other embodiments, techniques of this disclosure are implemented in non-multi-tenant environments such as client/server environments, cloud computing environments, clustered computers, etc.

MTS 700, in various embodiments, is a set of computer systems that together provide various services to users (or sets of users alternatively referred to as “tenants”) that interact with MTS 700. In some embodiments, MTS 700 implements a customer relationship management (CRM) system that provides mechanism for tenants (e.g., companies, government bodies, etc.) to manage their relationships and interactions with customers and potential customers. For example, MTS 700 might enable tenants to store customer contact information (e.g., a customer's website, email address, telephone number, and social media data), identify sales opportunities, record service issues, and manage marketing campaigns. Furthermore, MTS 700 may enable those tenants to identify how customers have been communicated with, what the customers have bought, when the customers last purchased items, and what the customers paid. To provide the services of a CRM system and/or other services, as shown, MTS 700 includes a database platform 710 and an application platform 720.

Database platform 710, in various embodiments, is a combination of hardware elements and software routines that implement database services for storing and managing data of MTS 700, including tenant data. As shown, database platform 710 includes data storage 712. Data storage 712, in various embodiments, includes a set of storage devices (e.g., solid state drives, hard disk drives, etc.) that are connected together on a network (e.g., a storage attached network (SAN)) and configured to redundantly store data to prevent data loss. Data storage 712 may implement a single database, a distributed database, a collection of distributed databases, a database with redundant online or offline backups or other redundancies, etc. In various embodiments, data storage 712 implements persistent storage 130 discussed above.

In various embodiments, a database record may correspond to a row of a table. A table generally contains one or more data categories that are logically arranged as columns or fields in a viewable schema. Accordingly, each record of a table may contain an instance of data for each category defined by the fields. For example, a database may include a table that describes a customer with fields for basic contact information such as name, address, phone number, fax number, etc. A record therefore for that table may include a value for each of the fields (e.g., a name for the name field) in the table. Another table might describe a purchase order, including fields for information such as customer, product, sale price, date, etc. In various embodiments, standard entity tables are provided for use by all tenants, such as tables for account, contact, lead and opportunity data, each containing pre-defined fields. MTS 700 may store, in the same table, database records for one or more tenants—that is, tenants may share a table. Accordingly, database records, in various embodiments, include a tenant identifier that indicates the owner of a database record. As a result, the data of one tenant is kept secure and separate from that of other tenants so that that one tenant does not have access to another tenant's data, unless such data is expressly shared.

In some embodiments, data storage 712 is organized as part of a log-structured merge-tree (LSM tree). As noted above, a database server 714 may initially write database records into a local in-memory buffer data structure before later flushing those records to the persistent storage (e.g., in data storage 712). As part of flushing database records, the database server 714 may write the database records into new files/extents that are included in a “top” level of the LSM tree. Over time, the database records may be rewritten by database servers 714 into new files included in lower levels as the database records are moved down the levels of the LSM tree. In various implementations, as database records age and are moved down the LSM tree, they are moved to slower and slower storage devices (e.g., from a solid-state drive to a hard disk drive) of data storage 712.

When a database server 714 wishes to access a database record for a particular key, the database server 714 may traverse the different levels of the LSM tree for files that potentially include a database record for that particular key. If the database server 714 determines that a file may include a relevant database record, the database server 714 may fetch the file from data storage 712 into a memory of the database server 714. The database server 714 may then check the fetched file for a database record having the particular key. In various embodiments, database records are immutable once written to data storage 712. Accordingly, if the database server 714 wishes to modify the value of a row of a table (which may be identified from the accessed database record), the database server 714 writes out a new database record into the buffer data structure, which is purged to the top level of the LSM tree. Over time, that database record is merged down the levels of the LSM tree. Accordingly, the LSM tree may store various database records for a database key such that the older database records for that key are located in lower levels of the LSM tree then newer database records.

Database servers 714, in various embodiments, are hardware elements, software routines, or a combination thereof capable of providing database services, such as data storage, data retrieval, and/or data manipulation Such database services may be provided by database servers 714 to components (e.g., application servers 722) within MTS 700 and to components external to MTS 700. As an example, a database server 714 may receive a database transaction request from an application server 722 that is requesting data to be written to or read from data storage 712. The database transaction request may specify an SQL SELECT command to select one or more rows from one or more database tables. The contents of a row may be defined in a database record and thus database server 714 may locate and return one or more database records that correspond to the selected one or more table rows. In various cases, the database transaction request may instruct database server 714 to write one or more database records for the LSM tree—database servers 714 maintain the LSM tree implemented on database platform 710. In some embodiments, database servers 714 implement a relational database management system (RDMS) or object-oriented database management system (OODBMS) that facilitates storage and retrieval of information against data storage 712. In various cases, database servers 714 may communicate with each other to facilitate the processing of transactions. For example, database server 714A may communicate with database server 714N to determine if database server 714N has written a database record into its in-memory buffer for a particular key.

Application platform 720, in various embodiments, is a combination of hardware elements and software routines that implement and execute CRM software applications as well as provide related data, code, forms, web pages and other information to and from user systems 750 and store related data, objects, web page content, and other tenant information via database platform 710. In order to facilitate these services, in various embodiments, application platform 720 communicates with database platform 710 to store, access, and manipulate data. In some instances, application platform 720 may communicate with database platform 710 via different network connections. For example, one application server 722 may be coupled via a local area network and another application server 722 may be coupled via a direct network link. Transfer Control Protocol and Internet Protocol (TCP/IP) are exemplary protocols for communicating between application platform 720 and database platform 710, however, it will be apparent to those skilled in the art that other transport protocols may be used depending on the network interconnect used.

Application servers 722, in various embodiments, are hardware elements, software routines, or a combination thereof capable of providing services of application platform 720, including processing requests received from tenants of MTS 700. Application servers 722, in various embodiments, can spawn environments 724 that are usable for various purposes, such as providing functionality for developers to develop, execute, and manage applications. Data may be transferred into an environment 724 from another environment 724 and/or from database platform 710. In some cases, environments 724 cannot access data from other environments 724 unless such data is expressly shared. In some embodiments, multiple environments 724 can be associated with a single tenant.

Application platform 720 may provide user systems 750 access to multiple, different hosted (standard and/or custom) applications, including a CRM application and/or applications developed by tenants. In various embodiments, application platform 720 may manage creation of the applications, testing of the applications, storage of the applications into database objects at data storage 712, execution of the applications in an environment 724 (e.g., a virtual machine of a process space), or any combination thereof. In some embodiments, application platform 720 may add and remove application servers 722 from a server pool at any time for any reason, there may be no server affinity for a user and/or organization to a specific application server 722. In some embodiments, an interface system (not shown) implementing a load balancing function (e.g., an F6 Big-IP load balancer) is located between the application servers 722 and the user systems 750 and is configured to distribute requests to the application servers 722. In some embodiments, the load balancer uses a least connections algorithm to route user requests to the application servers 722. Other examples of load balancing algorithms, such as are round robin and observed response time, also can be used. For example, in certain embodiments, three consecutive requests from the same user could hit three different servers 722, and three requests from different users could hit the same server 722.

In some embodiments, MTS 700 provides security mechanisms, such as encryption, to keep each tenant's data separate unless the data is shared. If more than one server 714 or 722 is used, they may be located in close proximity to one another (e.g., in a server farm located in a single building or campus), or they may be distributed at locations remote from one another (e.g., one or more servers 714 located in city A and one or more servers 722 located in city B). Accordingly, MTS 700 may include one or more logically and/or physically connected servers distributed locally or across one or more geographic locations.

One or more users (e.g., via user systems 750) may interact with MTS 700 via network 740. User system 750 may correspond to, for example, a tenant of MTS 700, a provider (e.g., an administrator) of MTS 700, or a third party. Each user system 750 may be a desktop personal computer, workstation, laptop, PDA, cell phone, or any Wireless Access Protocol (WAP) enabled device or any other computing device capable of interfacing directly or indirectly to the Internet or other network connection. User system 750 may include dedicated hardware configured to interface with MTS 700 over network 740. User system 750 may execute a graphical user interface (GUI) corresponding to MTS 700, an HTTP client (e.g., a browsing program, such as Microsoft's Internet Explorer™ browser, Netscape's Navigator™ browser, Opera's browser, or a WAP-enabled browser in the case of a cell phone, PDA or other wireless device, or the like), or both, allowing a user (e.g., subscriber of a CRM system) of user system 750 to access, process, and view information and pages available to it from MTS 700 over network 740. Each user system 750 may include one or more user interface devices, such as a keyboard, a mouse, touch screen, pen or the like, for interacting with a graphical user interface (GUI) provided by the browser on a display monitor screen, LCD display, etc. in conjunction with pages, forms and other information provided by MTS 700 or other systems or servers. As discussed above, disclosed embodiments are suitable for use with the Internet, which refers to a specific global internetwork of networks. It should be understood, however, that other networks may be used instead of the Internet, such as an intranet, an extranet, a virtual private network (VPN), a non-TCP/IP based network, any LAN or WAN or the like.

Because the users of user systems 750 may be users in differing capacities, the capacity of a particular user system 750 might be determined one or more permission levels associated with the current user. For example, when a salesperson is using a particular user system 750 to interact with MTS 700, that user system 750 may have capacities (e.g., user privileges) allotted to that salesperson. But when an administrator is using the same user system 750 to interact with MTS 700, the user system 750 may have capacities (e.g., administrative privileges) allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level. There may also be some data structures managed by MTS 700 that are allocated at the tenant level while other data structures are managed at the user level.

In some embodiments, a user system 750 and its components are configurable using applications, such as a browser, that include computer code executable on one or more processing elements. Similarly, in some embodiments, MTS 700 (and additional instances of MTSs, where more than one is present) and their components are operator configurable using application(s) that include computer code executable on processing elements. Thus, various operations described herein may be performed by executing program instructions stored on a non-transitory computer-readable medium and executed by processing elements. The program instructions may be stored on a non-volatile medium such as a hard disk or may be stored in any other volatile or non-volatile memory medium or device as is well known, such as a ROM or RAM, or provided on any media capable of staring program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the disclosed embodiments can be implemented in any programming language that can be executed on a server or server system such as, for example, in C, C+, HTML, Java, JavaScript, or any other scripting language, such as VBScript.

Network 740 may be a LAN (local area network), WAN (wide area network), wireless network, point-to-point network, star network, token ring network, hub network, or any other appropriate configuration. The global internetwork of networks, often referred to as the “Internet” with a capital “I,” is one example of a TCP/IP (Transfer Control Protocol and Internet Protocol) network. It should be understood, however, that the disclosed embodiments may utilize any of various other types of networks.

User systems 750 may communicate with MTS 700 using TCP/IP and, at a higher network level, use other common Internet protocols to communicate, such as HTTP, FTP, AFS, WAP, etc. For example, where HTTP is used, user system 750 might include an HTTP client commonly referred to as a “browser” for sending and receiving HTTP messages from an HTTP server at MTS 700. Such a server might be implemented as the sole network interface between MTS 700 and network 740, but other techniques might be used as well or instead. In some implementations, the interface between MTS 700 and network 740 includes load sharing functionality, such as round-robin HTTP request distributors to balance loads and distribute incoming HTTP requests evenly over a plurality of servers.

In various embodiments, user systems 750 communicate with application servers 722 to request and update system-level and tenant-level data from MTS 700 that may require one or more queries to data storage 712. In some embodiments, MTS 700 automatically generates one or more SQL statements (the SQL query) designed to access the desired information. In some cases, user systems 750 may generate requests having a specific format corresponding to at least a portion of MTS 700. As an example, user systems 750 may request to move data objects into a particular environment 724 using an object notation that describes an object relationship mapping (e.g., a JavaScript object notation mapping) of the specified plurality of objects.

The various techniques described herein and all disclosed or suggested variations, may be performed by one or more computer programs. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

Similarly, systems that implement the methods described with respect to any of the disclosed techniques are also contemplated. One such environment in which the disclosed techniques may operate is a cloud computer system. A cloud computer system (or cloud computing system) refers to a computer system that provides on-demand availability of computer system resources without direct management by a user. These resources can include servers, storage, databases, networking, software, analytics, etc. Users typically pay only for those cloud services that are being used, which can, in many instances, lead to reduced operating costs. Various types of cloud service models are possible. The Software as a Service (SaaS) model provides users with a complete product that is run and managed by a cloud provider. The Platform as a Service (PaaS) model allows for deployment and management of applications, without users having to manage the underlying infrastructure. The Infrastructure as a Service (IaaS) model allows more flexibility by permitting users to control access to networking features, computers (virtual or dedicated hardware), and data storage space. Cloud computer systems can run applications in various computing zones that are isolated from one another. These zones can be within a single or multiple geographic regions.

A cloud computer system includes various hardware components along with software to manage those components and provide an interface to users. These hardware components include a processor subsystem, which can include multiple processor circuits, storage, and I/O circuitry, all connected via interconnect circuitry. Cloud computer systems thus can be thought of as server computer systems with associated storage that can perform various types of applications for users as well as provide supporting services (security, load balancing, user interface, etc.).

One common component of a cloud computing system is a data center. As is understood in the art, a data center is a physical computer facility that organizations use to house their critical applications and data. A data center's design is based on a network of computing and storage resources that enable the delivery of shared applications and data.

The term “data center” is intended to cover a wide range of implementations, including traditional on-premises physical servers to virtual networks that support applications and workloads across pools of physical infrastructure and into a multi-cloud environment. In current environments, data exists and is connected across multiple data centers, the edge, and public and private clouds. A data center can frequently communicate across these multiple sites, both on-premises and in the cloud. Even the public cloud is a collection of data centers. When applications are hosted in the cloud, they are using data center resources from the cloud provider. Data centers are commonly used to support a variety of enterprise applications and activities, including, email and file sharing, productivity applications, customer relationship management (CRM), enterprise resource planning (ERP) and databases, big data, artificial intelligence, machine learning, virtual desktops, communications and collaboration services.

Data centers commonly include routers, switches, firewalls, storage systems, servers, and application delivery controllers. Because these components frequently store and manage business-critical data and applications, data center security is critical in data center design. These components operate together to provide the core infrastructure for a data center: network infrastructure, storage infrastructure and computing resources. The network infrastructure connects servers (physical and virtualized), data center services, storage, and external connectivity to end-user locations. Storage systems are used to store the data that is the fuel of the data center. In contrast, applications can be considered to be the engines of a data center. Computing resources include servers that provide the processing, memory, local storage, and network connectivity that drive applications. Data centers commonly utilize additional infrastructure to support the center's hardware and software. These include power subsystems, uninterruptible power supplies (UPS), ventilation, cooling systems, fire suppression, backup generators, and connections to external networks.

Data center services are typically deployed to protect the performance and integrity of the core data center components. Data center therefore commonly use network security appliances that provide firewall and intrusion protection capabilities to safeguard the data center. Data centers also maintain application performance by providing application resiliency and availability via automatic failover and load balancing.

One standard for data center design and data center infrastructure is ANSI/TIA-942. It includes standards for ANSI/TIA-942-ready certification, which ensures compliance with one of four categories of data center tiers rated for levels of redundancy and fault tolerance. A Tier 1 (basic) data center offers limited protection against physical events. It has single-capacity components and a single, nonredundant distribution path. A Tier 2 data center offers improved protection against physical events. It has redundant-capacity components and a single, nonredundant distribution path. A Tier 3 data center protects against virtually all physical events, providing redundant-capacity components and multiple independent distribution paths. Each component can be removed or replaced without disrupting services to end users. A Tier 4 data center provides the highest levels of fault tolerance and redundancy. Redundant-capacity components and multiple independent distribution paths enable concurrent maintainability and one fault anywhere in the installation without causing downtime.

Many types of data centers and service models are available. A data center classification depends on whether it is owned by one or many organizations, how it fits (if at all) into the topology of other data centers, the technologies used for computing and storage, and its energy efficiency. There are four main types of data centers. Enterprise data centers are built, owned, and operated by companies and are optimized for their end users. In many cases, they are housed on a corporate campus. Managed services data centers are managed by a third party (or a managed services provider) on behalf of a company. The company leases the equipment and infrastructure instead of buying it. In colocation (“colo”) data centers, a company rents space within a data center owned by others and located off company premises. The colocation data center hosts the infrastructure: building, cooling, bandwidth, security, etc., while the company provides and manages the components, including servers, storage, and firewalls. Cloud data centers are an off-premises form of data center in which data and applications are hosted by a cloud services provider such as AMAZON WEB SERVICES (AWS), MICROSOFT (AZURE), or IBM Cloud.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Where appropriate, it is also contemplated that claims drafted in one format or statutory type (e.g., apparatus) are intended to support corresponding claims of another format or statutory type (e.g., method).

References to a singular form of an item (i.e., a noun or noun phrase preceded by “a,” “an,” or “the”) are, unless context clearly dictates otherwise, intended to mean “one or more. ” Reference to “an item” in a claim thus does not, without accompanying context, preclude additional instances of the item. A “plurality”of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or”is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

What is claimed is:

1. A non-transitory computer-readable medium having program instructions stored thereon that are capable of causing a distributed computing system that includes a plurality of physical nodes implementing a hosting service to perform operations comprising:
deploying, to one or more of the physical nodes, a set of containers that implement a cache for a distributed database system hosted by the hosting service, wherein the set of containers are executable to store the cache in a memory internal to the one or more physical nodes;
determining a storage utilization for the set of containers; and
based on the determined storage utilization, redistributing data cached by a first of the containers to a second of the containers.

2. The non-transitory computer-readable medium of claim 1, wherein the operations further comprise:
determining a first storage utilization for the first container and a second storage utilization for the second container, wherein the data is redistributed based on a difference between the first storage utilization and the second storage utilization.

3. The non-transitory computer-readable medium of claim 2, wherein the operations further comprise:
determining an average utilization for the set of containers; and
determining if the first storage utilization exceeds the average utilization.

4. The non-transitory computer-readable medium of claim 3, wherein the operations further comprise:
in response to determining that the first storage utilization does not exceed the average utilization:
identifying, via a metadata server, an overutilized container within the set of containers, wherein the overutilized container has a third storage utilization that exceeds the average utilization;
retrieving, from a persistent storage, a subset of data cached by the overutilized container; and
storing the subset of data in a cache of the first container.

5. The non-transitory computer-readable medium of claim 4, wherein the operations further comprise:
deleting the subset of data from a cache of the overutilized container.

6. The non-transitory computer-readable medium of claim 1, wherein the redistributed data cached by the first of the containers to the second of the containers comprises a set of data extents, wherein the set of data extents comprises a set of data fragments.

7. The non-transitory computer-readable medium of claim 1, wherein the operations further comprise:
electing an auditor from the set of containers, wherein the auditor determines an average utilization for the set of containers.

8. The non-transitory computer-readable medium of claim 1, wherein the operations further comprise:
determining whether an average utilization for the set of containers satisfies a threshold; and
in response to determining that the average utilization satisfies the threshold, adding additional containers to the set of containers.

9. The non-transitory computer-readable medium of claim 1, wherein the operations further comprise:
determining whether an average utilization for the set of containers satisfies a threshold; and
in response to determining that the average utilization satisfies the threshold, removing one or more containers from the set of containers.

10. A non-transitory computer-readable medium having program instructions stored thereon that are capable of causing a distributed computing system that includes a plurality of physical nodes implementing a hosting service to perform operations comprising:
storing, by a first container deployed to one of the physical nodes, first data in a first cache for a distributed database system, wherein the cache is maintained in a memory internal to the physical node;
receiving, by the first container, a storage utilization associated with a second container maintaining a second cache for the distributed database system; and
redistributing, based on the received storage utilization, second data from the second cache of the second container to the first cache of the first container.

11. The non-transitory computer-readable medium of claim 10, wherein the operations further comprise:
sending, by the first container, a first storage utilization to a metadata server, wherein the received storage utilization is an average utilization determined based on the first storage utilization and a second storage utilization associated with the second container.

12. The non-transitory computer-readable medium of claim 10, wherein the operations further comprise:
reporting, by the first container, a request rate indicating a frequency the first container receives read and write requests, wherein the redistributing second data is further based on the request rate.

13. The non-transitory computer-readable medium of claim 10, wherein the operations further comprise:
participating in an election to determine an auditor within the set of containers, wherein the auditor provides an average storage utilization, wherein the average storage utilization is the received storage utilization.

14. A computer-implemented method, comprising:
receiving, via a metadata server, storage utilizations associated with a plurality of containers deployed to a plurality of physical nodes implementing a hosting service that hosts a distributed database system, wherein the plurality of containers implement a cache for the distributed database system;
determining an average storage utilization for the plurality of containers, wherein the average storage utilization is based on the storage utilizations for the plurality of containers; and
providing a report to the metadata server, wherein the report includes the average storage utilization and wherein the report is accessible to the plurality of containers to redistribute data among the plurality of containers.

15. The computer-implemented method of claim 14, further comprising:
determining an average access frequency associated with the plurality of containers, wherein the report includes the average access frequency.

16. The computer-implemented method of claim 14, wherein the computer-implemented method is performed by one of the plurality of containers.

17. The computer-implemented method of claim 16, wherein the one container is elected from among the plurality of containers.

18. The computer-implemented method of claim 14, wherein the average storage utilization is based on the data cached by the plurality of containers.

19. The computer-implemented method of claim 14, further comprising:
determining whether the average storage utilization for the plurality of containers satisfies a threshold; and
in response to determining that the average storage utilization satisfies the threshold, changing the number of containers within the plurality of containers.

20. The computer-implemented method of claim 14, wherein a first container within the plurality of containers is deployed to a first physical node located in a first area zone and a second container within the plurality of containers is deployed to a second physical node located in a second area zone, wherein the first area zone and the second area zone are in different geographical locations.
